(19) United States
(12) Patent Application Publication
(10) Pub. No.: US 2006/0011229 A1
(43) Pub. Date: Jan. 19, 2006

(54) Strength-conserving pneumatic walking stick

(76) Inventor: Mei-Chuan Tseng, Beidou Township (TW)

Correspondence Address: RABIN & BERDO, P.C.;Suite 500, 1101 14th Street, N.W., Washington, DC, 20005, US

(21) Appl. No.: 10/888,994

(22) Filed: Jul. 13, 2004

(51) Int. Cl. A61H 3/02

(52) U.S. Cl. 135/70; 135/71; 135/72

(57) ABSTRACT

A strength-conserving pneumatic walking stick comprised of a walking stick main member, an air pressure adjustor, and a support member, with the pneumatic walking stick air pressure adjustor situated inside the walking stick main member and mounted in the support member. When the user wants to sit or stand, physical strength supported on the pneumatic walking stick triggers the toggling of air pressure adjustor actuating lever, enabling the pneumatic spindle to articulate the extension and the retraction of the support member from the inside of the walking stick main member.

### BACKGROUND OF THE INVENTION

1) Field of the Invention

The invention herein relates to a strength-conserving pneumatic walking stick capable of providing supportive assistance to the ambulatorily handicapped or injured during the process of standing or sitting and thereby achieving a safe and reliable means of support with strength saving adjustability.

2) Description of the Prior Art

A currently observed walking stick 10 (referring to FIG. 1 and FIG. 2) is comprised of a walking stick main member 11 and a retractable stick member 15; a soft pad 12 is situated at the upper extent of the walking stick main member 11 and a hollow stanchion member 13 having a plurality of adjustment positioning holes 14 is situated along the lower extent; the retractable stick member 15 is sleeved into the walking stick main member 11 stanchion member 13, with an elastic retaining component 16 internally disposed at the upper extent of the retractable stick member 15 to provide for engaging the stanchion member 13 holes 14 and thereby maintaining stationary positioning, and an anti-slip cushion 17 is sleeved onto the lower extent of the retractable stick member 15; when the user wants to adjust the walking stick length, direct pressure against the elastic retaining component 16 disengages it from the stanchion member 13 hole 14 and then the retractable stick member 15 is pulled out of or pushed into the walking stick main member 11, following which the elastic retaining component 16 is re-engaged into the hole 14 to maintain the position, which thereby completes the length adjustment procedure.

As such, the prior art structure has the following drawbacks: 1) The walking stick 10 consists of retractable stick member 15 elastic retaining component 16 that engages a walking stick main member 11 hole 14 to maintain a fixed length and when the user wants to sit down, since the walking stick 10 must be postured at an angle before the user can slowly proceed to sit, during which time the walking stick 10 loses its supportive function, the center of gravity of the user is not stabilized and falling is possible. 2) When the user wants to stand up with the aid of the walking stick 10, since the walking stick 10 must set an angle and leaned on as the user slowly gets back up, this consumes strength and, furthermore, easily increases the possibility of a fall due to center of gravity instability.

In view of the said shortcomings, the applicant of the invention herein conceived of a thoughtful and original idea based on many years of design experience and extensive investigation that, following repeated sample testing and numerous refinements, culminated in the introduction of the invention herein.

### SUMMARY OF THE INVENTION

The primary objective of the invention herein is to provide a strength-conserving pneumatic walking stick in which the pneumatic walking stick air pressure adjustor is situated inside the walking stick main member and mounted in the support member; when the user wants to sit down or stand up, physical strength supported on the pneumatic walking stick triggers the toggling of an air pressure adjustor actuating lever, enabling the pneumatic spindle to articulate the extension and the retraction of the support member from the inside of the walking stick main member such that the user is not required to exert a great amount of strength and is afforded a reliable and stable supportive means.

### BRIEF DESCRIPTION OF THE DRAWINGS

FIG. 1 is an orthographic drawing of the prior art.

FIG. 2 is a cross-sectional drawing of a section of the prior art.

FIG. 3 is an isometric drawing of the invention herein.

FIG. 4 is a cross-sectional drawing of a section of the invention herein.

FIG. 5 is a cross-sectional drawing of the invention herein that illustrates operation.

FIG. 6 is an orthographic drawing of the invention herein that illustrates utilization.

FIG. 7 is an orthographic drawing of the invention herein that illustrates utilization.

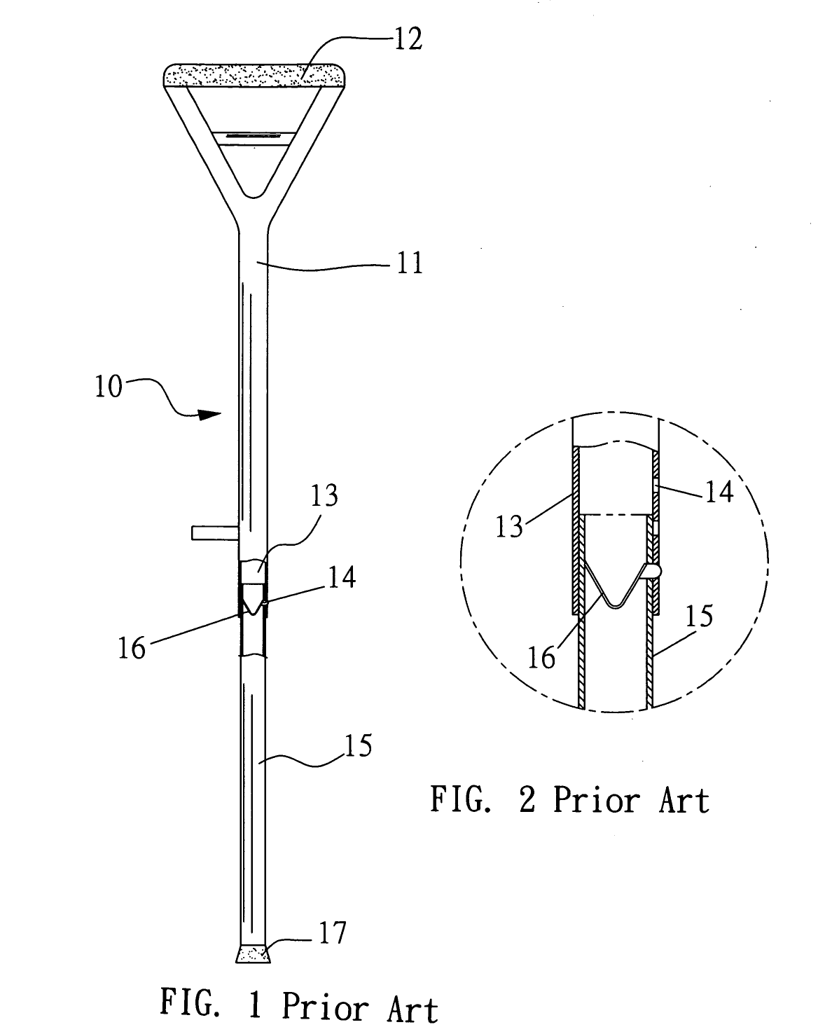

### DETAILED DESCRIPTION OF THE INVENTION

The brief description of the drawings are accompanied below by the detailed description of the present invention.

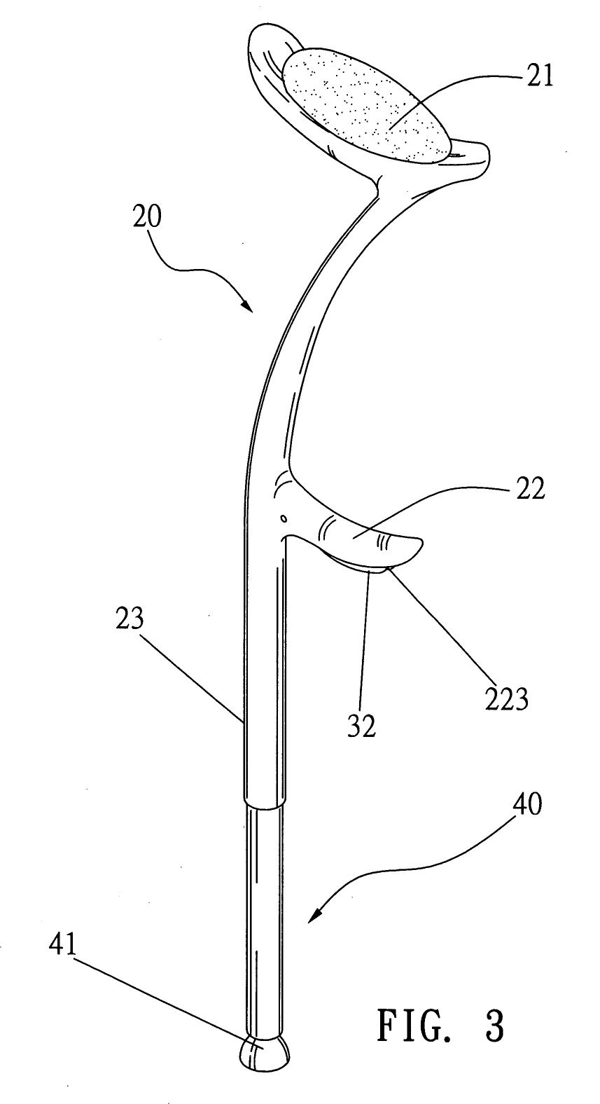

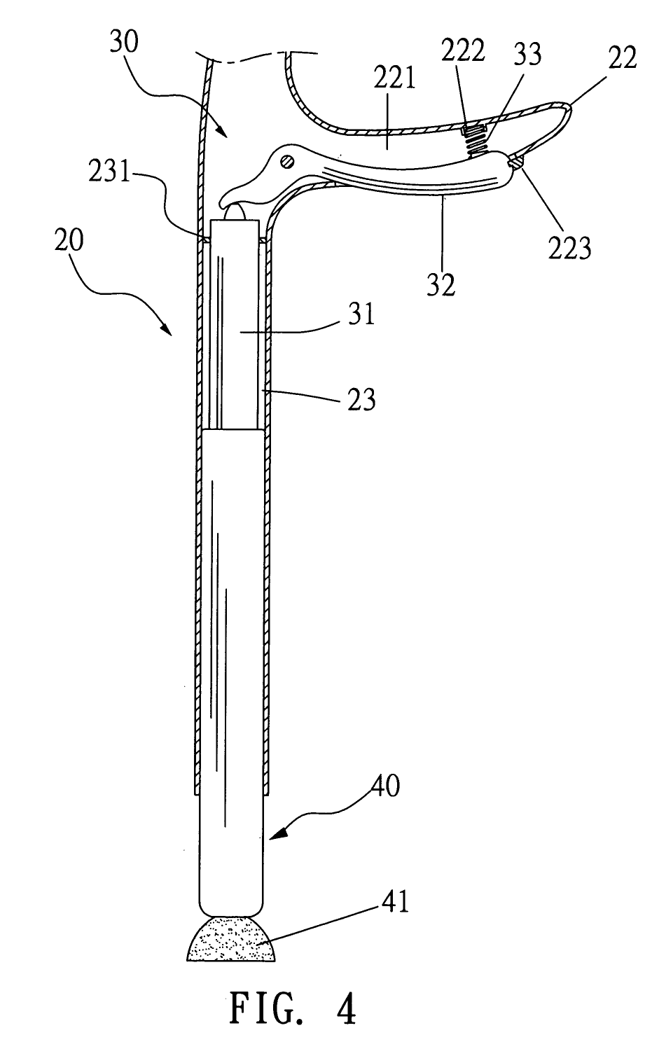

The strength-conserving pneumatic walking stick (referring to FIG. 3 and FIG. 4) is comprised of a walking stick main member 20, a spring 33, an air pressure adjustor 30, and a support member 40; a soft pad 21 is situated at the upper extent of the walking stick main member 20, a handle 22 projects from the middle to provide for manual grasping, a recess 221 is disposed downward along the bottom surface of the handle 22, a locating slot 222 is formed in the recess 221, a positioning switch 223 is situated at one side of the recess 221, a hollow tubular stanchion member 23 is situated downward from the handle 22, and a set flange 231 protrudes from a suitable area at the upper extent of the stanchion member 23 interior section; the air pressure adjustor 30 consists of a pneumatic spindle 31 having an actuating lever 32 at its upper extremity and a locating slot 321 formed in the actuating lever 32; the support member 40 is a hollow tubular construct having a non-slip cushion 41 sleeved onto its lower extent; when assembled, the upper extremity of the air pressure adjustor 30 pneumatic spindle 31 is fixed by the stanchion member 23 set flange 231 and the actuating lever 32 is contained in the handle 22 recess 221; the locating slot 222 in the recess 221 provides for the securing of one end of the spring 33 with the other end of the spring 33 resting against the actuating lever 32 upper edge surface; and the support member 40 is then mounted at the lower extremity of the air pressure adjustor 30 pneumatic spindle 31, thereby completing the assembly.

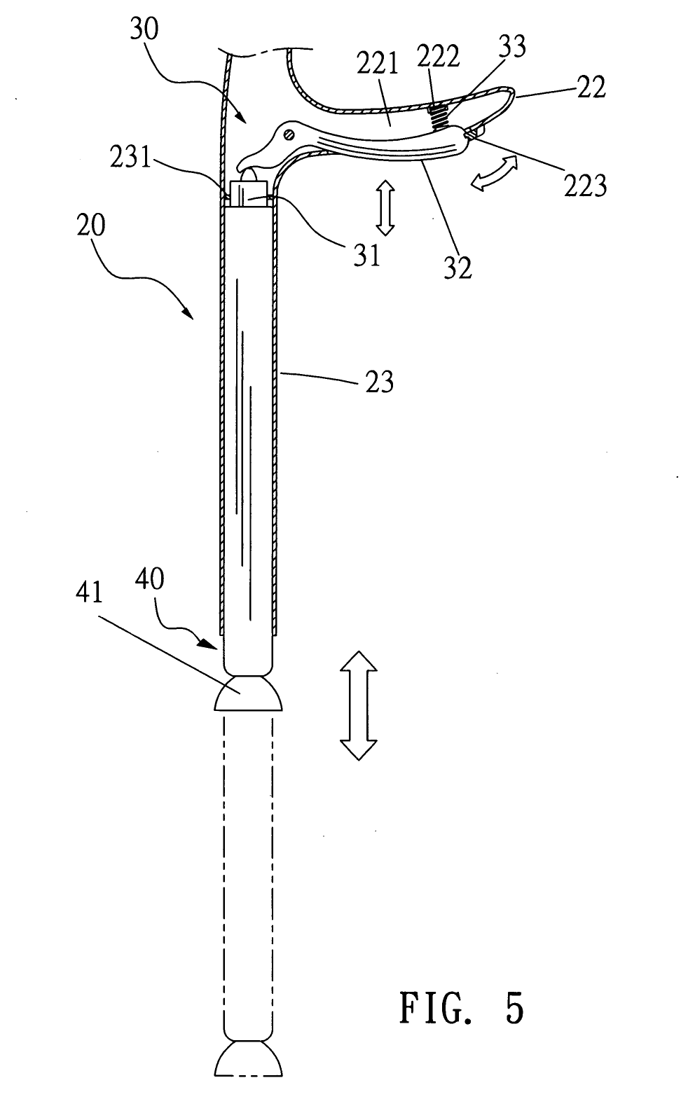

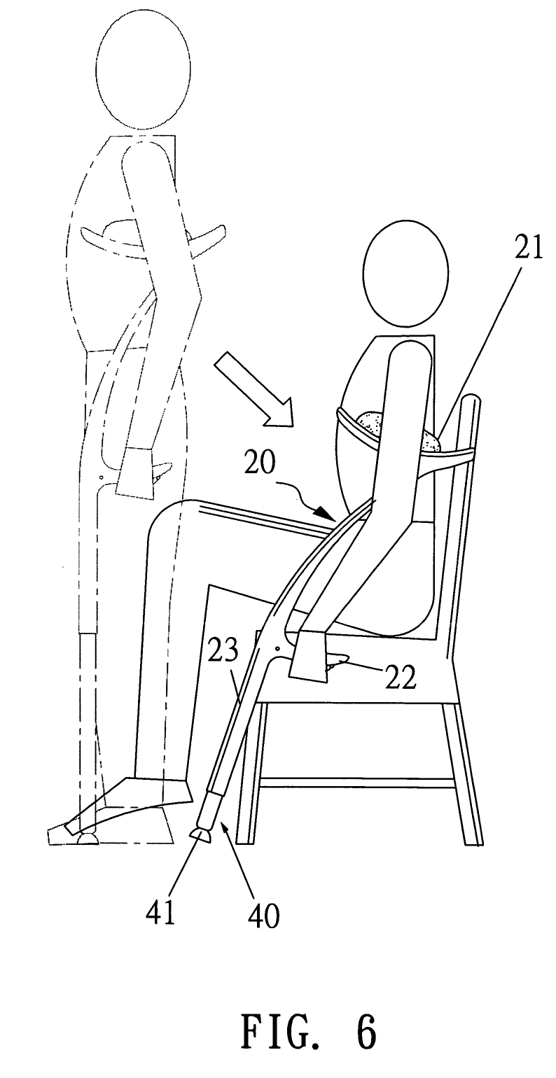

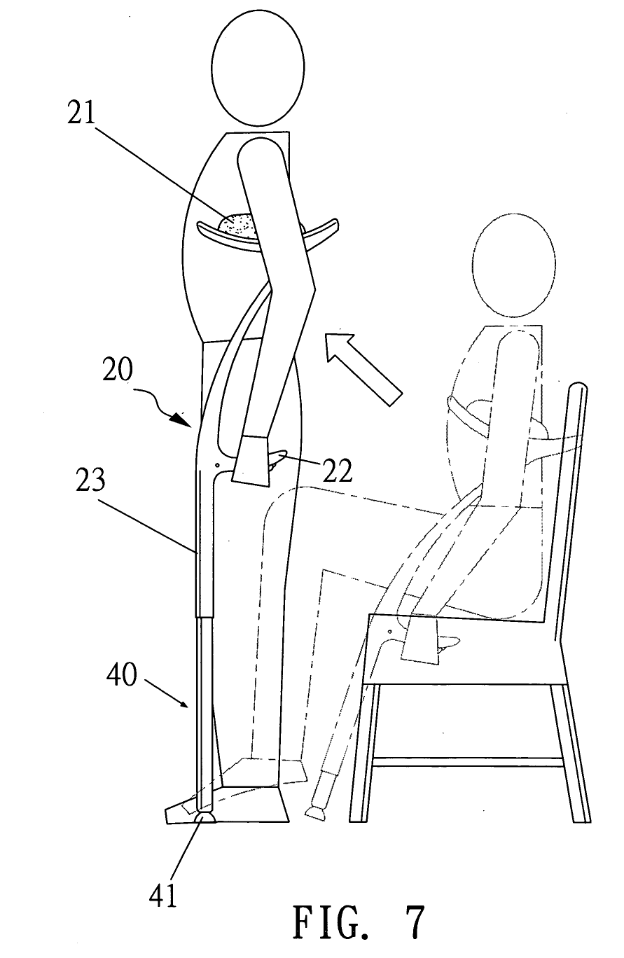

When the user utilizes the pneumatic walking stick (referring to FIG. 5, FIG. 6, and FIG. 7); when the user wants to sit, the armpit is exerted down against the pad 21 on the walking stick main member 20, which initially disengages the handle 22 positioning switch 223 from the actuating lever 32 locating slot 321 and next triggers the air pressure adjustor 30 actuating lever 32 such that the supported physical strength of the user is directed down towards the pneumatic spindle 31 on the walking stick main member 20 which simultaneously causes the retraction of the support member 40 into the stanchion member 23, and when the pneumatic walking stick is adjusted to the appropriate length, the positioning switch 223 once again toggles into stationary engagement in the actuating lever 32 locating slot 321, enabling the user to utilize the capability of pneumatic walking stick as a reliable and stable means of support while sitting down; when the user wants to stand, the armpit is exerted down against the pad 21 on the walking stick main member 20 to initially disengage the handle 22 positioning switch 223 from the actuating lever 32 locating slot 321 and next triggers the air pressure adjustor 30 actuating lever 32 such that the supported physical strength of the user is directed downward against the walking stick main member 20 and releases the air pressure adjustor 30 pneumatic spindle 31, causing the forceful extension of the support member 40 out from the stanchion member 23 and at a slow rate of rise until the full standing length is reached, whereupon the positioning switch 223 once again toggles into stationary engagement in the actuating lever 32 locating slot 321, enabling the user to utilize the capability of the pneumatic walking stick as a safe and stable means of support while standing up that does not require the exertion of considerable strength.

As such, the structure of the said general embodiments is capable of obtaining the following beneficial results: 1) When the user wants to sit, the supported physical strength of the user is directed down towards the pneumatic spindle 31 on the walking stick main member 20 which simultaneously causes the retraction of the support member 40 into the stanchion member 23, and when the pneumatic walking stick is adjusted to the appropriate length, the positioning switch 223 once again toggles into stationary engagement in the actuating lever 32 locating slot 321, enabling the user to utilize the capability of pneumatic walking stick as a reliable and stable means of support while sitting down. 2) When the user wants to stand, the supported physical strength of the user is directed downward against the walking stick main member 20 and releases the air pressure adjustor 30 pneumatic spindle 31, causing the forceful extension of the support member 40 out from the stanchion member 23 and at a slow rate of rise until the full standing length is reached, whereupon the positioning switch 223 once again toggles into stationary engagement in the actuating lever 32 locating slot 321, enabling the user to utilize the capability of the pneumatic walking stick as a safe and stable means of support while standing up that does not require the exertion of considerable strength.

In summation of the foregoing section, since the invention herein is already of an advanced innovative structure that possesses improved original content, while also capable of achieving industrial utility and progressiveness, and thus meets patent law regulations, the present invention is lawfully submitted for patent application to the patent bureau for review and the granting of the commensurate patent rights.

However, the said description only elaborates the most preferred embodiments of the invention herein and shall not be construed as limitation of the scope of the present invention; all modification and embellishments based on the patent application claims of invention herein shall remain proprietary to and protected under the claims of present invention.

1. A strength-conserving pneumatic walking stick comprised of a walking stick main member, a spring, an air pressure adjustor, and a support member; a soft pad is situated at the upper extent of the said walking stick main member, a handle projects from the middle to provide for manual grasping, a recess is disposed downward along the bottom surface of the said handle, and the said support member is a hollow tubular construct having a non-slip cushion sleeved onto its lower extent, the features of which are: The said air pressure adjustor consists of a pneumatic spindle having an actuating lever at its upper extremity, the said actuating lever is contained in the said walking stick main member against the said spring at the upper extent of the said handle recess, the upper end of the said pneumatic spindle is fixed inside the said walking stick main member stanchion member, its lower end mounted in the said walking stick main member such that the said pneumatic spindle articulates the extension and the retraction of the said support member from the inside of the said walking stick main member.
